(19) United States
(12) Patent Application Publication
(10) Pub. No.: US 2007/0182378 A1
(43) Pub. Date: Aug. 9, 2007

(54) Information processing apparatus and battery capacity measuring method

(76) Inventor: Kazuhiki Tsuji, Hamura-shi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/699,823

(22) Filed: Jan. 30, 2007

(30) Foreign Application Priority Data
Jan. 31, 2006 (JP) 2006-023406

(51) Int. Cl. H02J 7/00

(52) U.S. Cl. 320/132

(57) ABSTRACT

According to one embodiment, there is provided an information processing apparatus including a battery, a detection unit to detect a value of current discharged from the battery, a device to be driven upon receipt of the current discharged from the battery, a control unit to control the device to ensure that the value of current detected by the detection unit approaches a preset value, and a computation unit to compute a capacity of the battery, based on the value of current detected by the detection unit, while the control unit controls the device.

### CROSS-REFERENCE TO RELATED APPLICATIONS

This application is based upon and claims the benefit of priority from Japanese Patent Application No. 2006-023406, filed Jan. 31, 2006, the entire contents of which are incorporated herein by reference.

### BACKGROUND

1. Field

One embodiment of the invention relates to an information processing apparatus capable of measuring the capacity of a battery, and a method of measuring the capacity of a battery.

2. Description of the Related Art

An information processing apparatus such as a personal computer includes a battery. In order to diagnose the degradation state of the battery, generally, a tool called a battery capacity measurement tool or a degradation state diagnosis tool is used. For example, Jpn. Pat. Appln. KOKAI Publication No. 2002-247773 discloses a degradation state diagnosis program for diagnosing the degradation state of a secondary battery on the basis of the amount of electric discharge of a battery.

The battery capacity to be measured varies with discharge current. If the above-described tool is employed, the battery is discharged and its discharge current is measured. The discharge current varies depending on the operating conditions and use environment of an information processing apparatus. For this reason, the capacity of the battery cannot be measured correctly or an exact diagnostic result cannot be obtained.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view of a computer according to an embodiment of the invention, the display unit of which is open;

FIG. 2 is an exemplary block diagram showing a system configuration of the computer according to the embodiment of the invention;

FIG. 3 is an exemplary block diagram showing a configuration of each of the functions related to the measurement of the capacity of a battery;

FIG. 4 is an exemplary block diagram showing a configuration of each of the functions of a battery capacity measurement tool shown in FIG. 3;

FIG. 5 is an exemplary diagram showing an example of a setting screen implemented by a setting unit of the battery capacity measurement tool;

FIG. 6 is an exemplary table showing some contents of a fixed-data division in an EEPROM of the battery;

FIG. 7 is an exemplary table showing some contents of a variable-data division in the EEPROM of the battery;

FIG. 8 is an exemplary graph showing a relationship between battery capacity and time in battery capacity measurement;

FIG. 9 is an exemplary flowchart showing the entire operation of the computer regarding the battery capacity measurement; and

FIG. 10 is an exemplary flowchart showing an operation related to the control of discharge current during electric discharge.

### DETAILED DESCRIPTION

Various embodiments according to the invention will be described hereinafter with reference to the accompanying drawings. In general, according to one embodiment of the invention, there is provided an information processing apparatus including a battery, a detection unit to detect a value of current discharged from the battery, a device to be driven upon receipt of the current discharged from the battery, a control unit to control the device to ensure that the value of current detected by the detection unit approaches a preset value, and a computation unit to compute a capacity of the battery, based on the value of current detected by the detection unit, while the control unit controls the device.

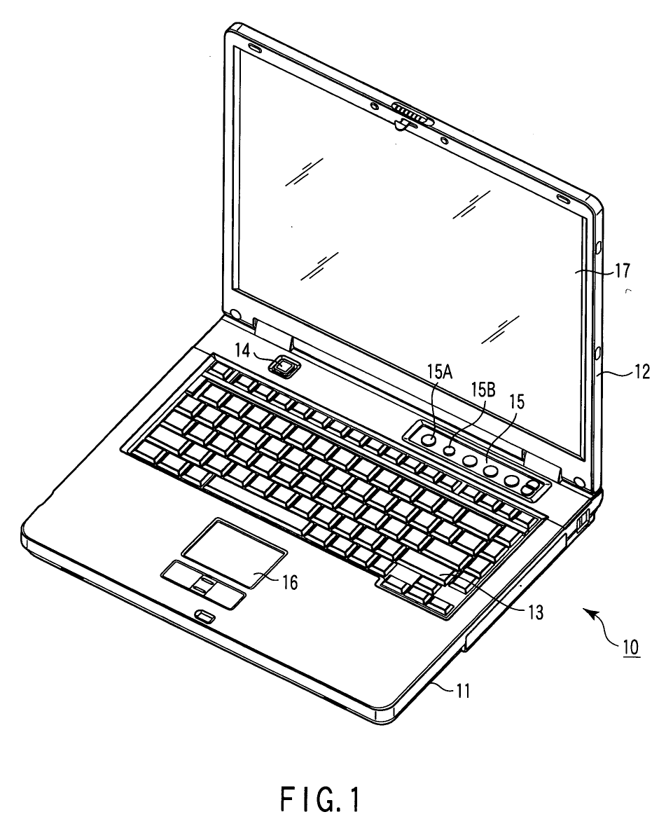

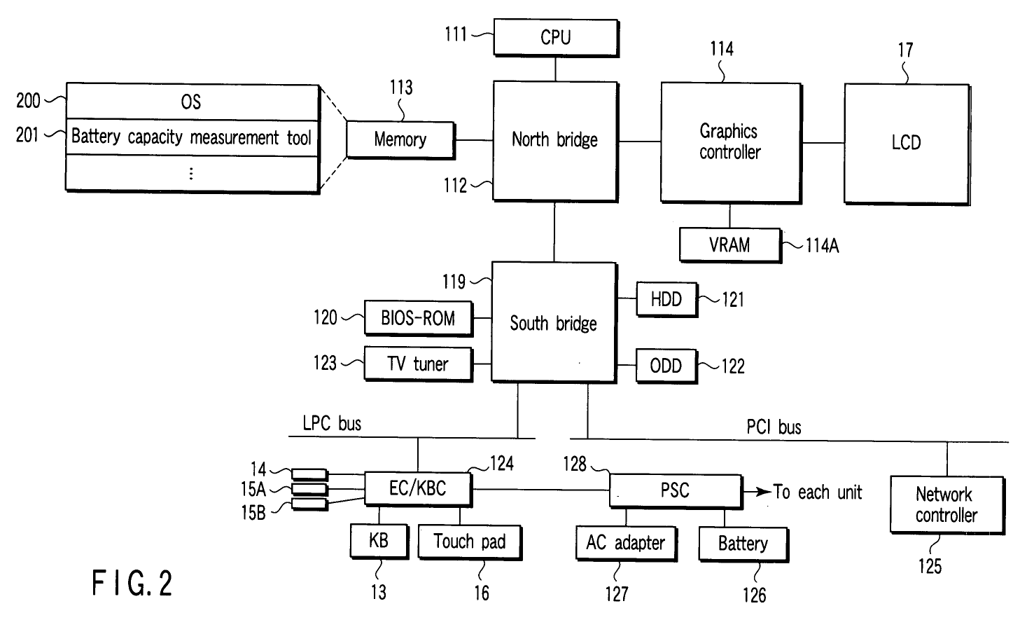

Referring first to FIGS. 1 and 2, the configuration of an information processing apparatus according to the embodiment of the invention will be described. The information processing apparatus is implemented as a notebook personal computer 10, for example.

FIG. 1 is a perspective view of the notebook personal computer 10 whose display unit is open. The computer 10 includes a main body 11 and a display unit 12. The display unit 12 incorporates a display device that is composed of a thin-film transistor liquid crystal display (TFT-LCD) 17. The display screen of the TFT-LCD 17 is located in almost the central part of the display unit 12.

The display unit 12 is attached to the main body 11 to ensure that it can freely turn between its open position and closed position. The main body 11 has a thin box-shaped cabinet. A keyboard 13, a power button 14, an input operation panel 15 and a touch pad 16 are arranged on the top of the main body 11. The power button 14 is used to power on/power off the computer 10.

The input operation panel 15 is an input device for inputting an event corresponding to a depressed button. The panel 15 includes a plurality of buttons for starting a plurality of functions. These buttons include a TV start button 15A and a DVD/CD start button 15B. The TV start button 15A is a button for starting a TV function of recording, playing back and listening to TV broadcast program data. The DVD/CD start button 15B is a button for playing back video contents from a DVD or a CD.

The system configuration of the computer 10 will be described with reference to FIG. 2.

Referring to FIG. 2, the computer 10 includes a CPU 111, a north bridge 112, a main memory 113, a graphics controller 114, a south bridge 119, a BIOS-ROM 120, a hard disk drive (HDD) 121, an optical disk drive (ODD) 122, a TV tuner 123, an embedded controller/keyboard controller IC (EC/KBC) 124, a network controller 125, a battery 126, an AC adapter 127 and a power supply controller (PSC) 128.

The CPU 111 is a processor for controlling the operation of the computer 10. The CPU 111 executes software such as an operating system (OS) 200 and a battery capacity measurement tool 201, which are loaded into the main memory 113 from the HDD 121.

The CPU 111 also executes a system basic input/output system (BIOS) stored in the BIOS-ROM 120. The system BIOS is a program for control of hardware.

The north bridge 112 is a bridge device that connects a local bus of the CPU 111 and the south bridge 119. The north bridge 112 incorporates a memory controller for controlling access to the main memory 113. The north bridge 112 has a function of communicating with the graphics controller 114 via an accelerated graphics port (AGP) bus and the like.

The graphics controller 114 is a display controller for controlling the LCD 17. The LCD 17 is used as a display monitor of the computer 10. The graphics controller 114 displays video data, which is written to a video memory (VRAM) 114a, on the LCD 17.

The south bridge 119 controls each of the devices on a low pin count (LPC) bus and a peripheral component interconnect (PCI) bus. The south bridge 119 incorporates an integrated drive electronics (IDE) controller for controlling the HDD 121 and ODD 122. The south bridge 119 has a function of controlling the TV tuner 123 and a function of controlling access to the BIOS-ROM 120.

The HDD 121 is a storage device for storing various types of software and data. The ODD 122 is a drive unit for driving storage media such as a DVD and a CD, which store video contents. The TV tuner 123 is a receiving device for receiving broadcast program data such as TV broadcast programs from an external device.

The network controller 125 is a communication device which communicates with an external network such as the Internet.

The EC/KBC 124 is a single-chip microcomputer on which an embedded controller for managing power and a keyboard controller for controlling the keyboard (KB) 13 and touch pad 16 are integrated.

The power supply controller (PSC) 128 is a device which generates a power supply voltage necessary for each component of the computer 10 and applies the power supply voltage to the component. The power supply voltage is generated in response to an instruction from the embedded controller (EC) on the basis of the power supply voltage of the battery 126 or the external power supply voltage externally supplied via the AC adapter 127.

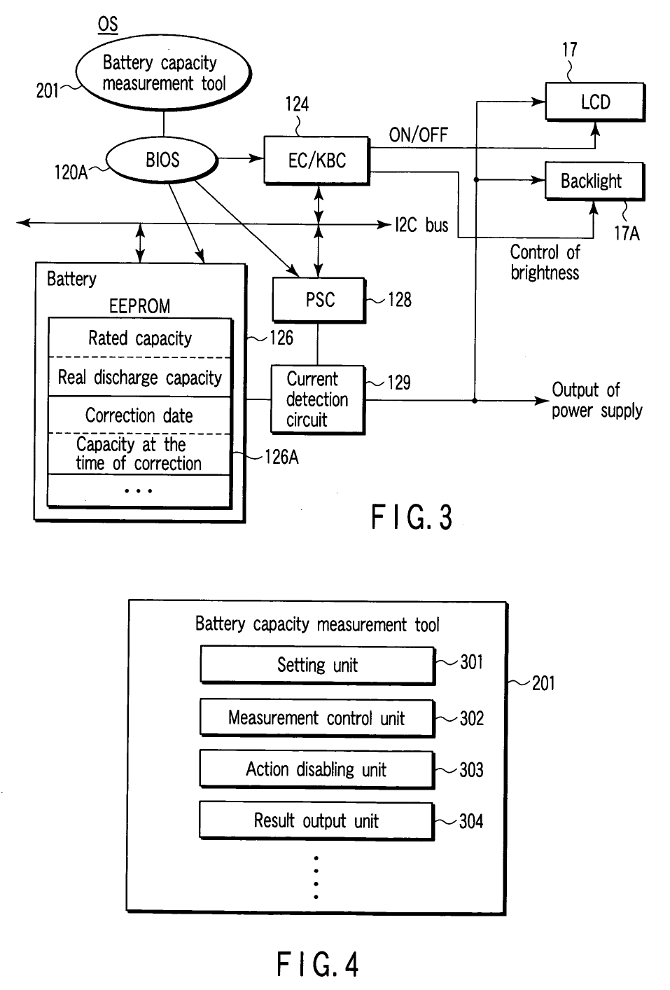

FIG. 3 is a block diagram showing a configuration of each of the functions related to the measurement of the capacity of the battery 126.

The battery capacity measurement tool 201 is implemented in the form of utility managed by an OS 200, for example. The tool 201 is software used to measure the capacity of the battery 126. The battery capacity corresponds to the amount of electricity that is obtained until the terminal voltage of the completely charged battery reaches a preset discharge stop voltage. The battery capacity is expressed by the product of discharge capacity and discharge time. In actuality, the discharge capacity (e.g., 95% discharge capacity) of the battery from a full charge state to a low battery state is measured. This discharge capacity is converted into battery capacity (namely, 100% discharge capacity).

When the battery capacity measurement tool 201 starts up, it is able to explain the operating instructions and cautions of the computer to a user on the display. The tool 201 is also able to make various settings before its measurement starts and send various commands for measurement to a BIOS 120A. Further, the tool 201 is able to monitor various states related to measurement through the BIOS 120A.

A current detection circuit 129 detects the current discharged from the battery 126.

The PSC 128 can control the battery 126 so that the battery 126 is placed into a discharge state at a starting of discharge of the battery 126. Furthermore, the PSC 128 can continuously detect the discharge current (real current) of the battery 126 through the current detection circuit 129 and write the values of the real current and the discharge time thereof to the EC/KBC 124 one by one. The PSC 128 can also write the discharge capacity which is a product of discharge current (real current) and discharge time to the EC/KBC 124. Moreover, the PSC 128 can detect that the discharged battery 126 has reached a low battery state through, e.g., the terminal voltage of the battery 126, and write the discharge capacity, which is obtained from the information written to the EC/KBC 124, to a variable-data division in an EEPROM 126A.

The EC/KBC 124 can turn on/turn off the LCD 17 in accordance with the direction from the BIOS 120A and change the brightness of a backlight 17A of the LCD 17.

The EEPROM 126A is included in the battery 126. The EEPROM 126A has a fixed-data division for storing data that cannot be varied (e.g., rated battery capacity and discharge capacity) and a variable-data division for storing variable data (e.g., corrected year, month and day, and full charge capacity at the time of correction).

The BIOS 120A can control the EC/KBC 124, PSC 128, battery 126, etc. in accordance with the direction from the battery capacity measurement tool 201. The BIOS 120A can also acquire various types of information from the EC/KBC 124, PSC 128, battery 126, etc. and notify the tool 201 of the information.

In particular, the BIOS 120A can control the state of a device of the computer 10 to ensure that the value of the discharge current detected by the current detection circuit 129 can approach a preset proper value (e.g., 20% to 30% of the rated value). For example, the BIOS 120A can turn on/turn off the LCD 17, heighten/lower the brightness of the backlight 17A, or increase/decrease the operating frequency of the CPU 111.

More specifically, the BIOS 120A computes the value of proper current from the value of the rated capacity stored in the EEPROM 126A, and compares it with the value of the real current stored in the EC/KBC 124. If the value of the real current is larger than the value of proper current, the BIOS 120A reduces the power consumption of the above device to ensure that the value of the real current may become small. On the other hand, if the value of the real current is smaller than the value of proper current, the BIOS 120A increases the power consumption of the device to ensure that the value of the real current may become large.

After measurement, the BIOS 120A can read the value of the discharge capacity from the variable-data division in the EEPROM 126A and notify the battery capacity measurement tool 201 of the value of the discharge capacity.

The BIOS 120A or PSC 128 can measure a time period during which the battery 126 is discharged. Further, the BIOS 120A or PSC 128 can compute the capacity of the battery 126 by the product of the value of the current detected by the current detection circuit 129 under the control of the state of the above device and the value of the measured time period under the control of the state of the device.

FIG. 4 is a block diagram showing a configuration of each of the functions of the battery capacity measurement tool 201 shown in FIG. 3.

The battery capacity measurement tool 201 has various functions such as a setting unit 301, a measurement control unit 302, an action disabling unit 303 and a result output unit 304.

The setting unit 301 makes various settings related to battery capacity measurement.

The measurement control unit 302 sends various commands for measurement to the BIOS 120A and monitors various states about measurement through the BIOS 120A.

When a panel closing operation (an operation for closing the display unit 12 toward the main body 11) is performed during measurement, the action disabling unit 303 disables an action setting so as to inhibit the computer from shifting to a suspend state or a hibernation state, and controls the computer to continue the measurement.

The result output unit 304 displays on the screen the measurement results of the battery capacity, etc., which are obtained through the BIOS 120A.

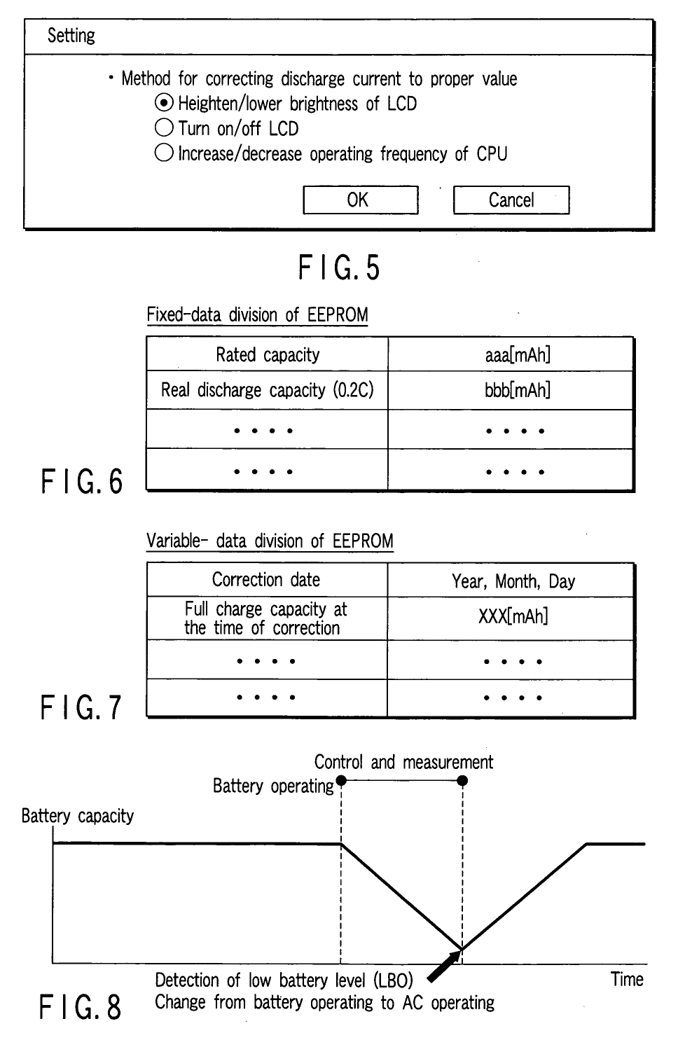

FIG. 5 is a diagram showing an example of a setting screen implemented by the setting unit 301 of the battery capacity measurement tool 201. The setting unit 301 of the battery capacity measurement tool 201 can display a setting screen as shown in FIG. 5 on the LCD 17. In order to correct the current discharged from the battery 126 during measurement to have a proper value, a user can specify any one of the following methods on the setting screen: “heighten/lower the brightness of the LCD,” “turn on/turn off the LCD” and “increase/decrease the operating frequency of the CPU.”

FIG. 6 is a table showing some contents of the fixed-data division in the EEPROM 126A of the battery 126. The fixed-data division stores in advance the rated capacity and real discharge capacity of the battery 126. These values are used to obtain, for example, the proper value of the discharge current.

FIG. 7 is a table showing some contents of the variable-data division in the EEPROM 126A of the battery 126. The variable-data division stores, for example, the date (year, month and day) corrected in battery capacity measurement and the full charge capacity at the time of the correction. These values are used to record the results of the battery capacity measurement.

FIG. 8 is a graph showing a relationship between the battery capacity and time in the battery capacity measurement.

If the computer 10 is forcibly placed into a battery-operated state, the battery 126 in its full charge state starts to be discharged. Discharge current is controlled and measured while the computer is being operated by the battery 126. If the battery 126 is discharged and reaches a low battery state, its discharge stops. The battery 126 is switched to an AC operating state from a battery-operated state.

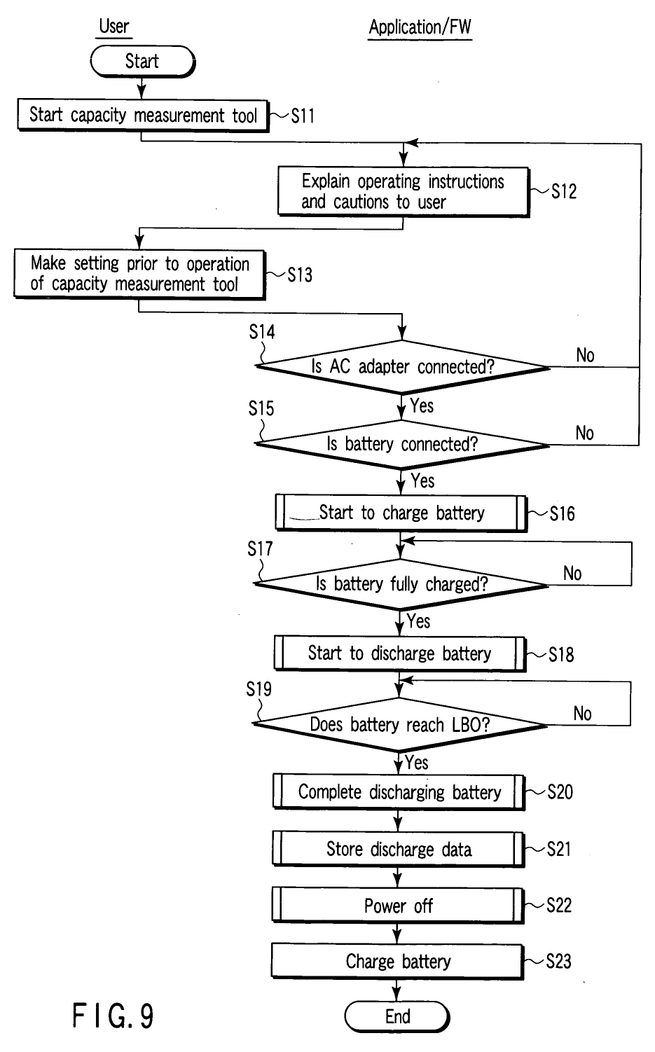

Referring next to FIG. 9, the entire operation of the computer regarding battery capacity measurement will be described.

If the capacity measurement tool 201 is started by the operation of a user (block S11), it explains the operating instructions and cautions of the battery capacity measurement to the user on the screen of the LCD 17 (block S12). If the user makes a setting prior to the battery capacity measurement in accordance with the explanations (block S13), the capacity measurement tool 201 checks the connection state of the AC adapter 127 and that of the battery 126 (blocks S14 and S15). If at least one of the AC adapter 127 and battery 126 is not connected to the computer, the process returns to block S12, and the tool 201 explains the operating cautions and the like to the user again.

If the capacity measurement tool 201 confirms the connection of the AC adapter 127 or the battery 126, it issues a command indicating the full charge of the battery 126. If this command is transmitted to the PSC 128 through the BIOS 120A, the PSC 128 starts to charge the battery 126 (block S16).

The capacity measurement tool 201 continues to monitor the state of the battery 126 until the battery 126 reaches a fully-charged level (block S17). The PSC 128 writes information indicating whether the battery 126 is in a fully-charged state to the EC/KBC 124. The BIOS 120A checks the information in the EC/KBC 124 to determine whether the battery 126 reaches the fully-charged level. Then, the BIOS 120A notifies the capacity measurement tool 201 of the determination result.

When the capacity measurement tool 201 confirms that the battery 126 reaches the full-charged level, it issues a command that indicates the operation of the battery 126 (or a command that indicates the discharge of the battery 126). If this command is transmitted to the PSC 128 through the BIOS 120A, the PSC 128 starts to discharge the battery 126 (block S18). During the discharge of the battery 126, the set action (e.g., the shift to a standby state or a hibernation state) is inhibited from being performed even though an operation such as a panel closing operation is carried out. In this discharge process, the value of the discharge current is corrected as will be described later, and thus a value of the discharge capacity which corresponds to the corrected value of the discharge current is obtained.

The capacity measurement tool 201 continues to monitor the state of the battery 126 until the battery 126 reaches a low-battery level (LB0) (block S19). When the PSC 128 detects that the battery 126 reaches the low-battery level, it completes discharging the battery 126 (block S20). Then, the PSC 128 writes the measured value of the discharge capacity and that of the discharge time to the EEPROM 126A, and shifts from the operation of the battery to that of the AC adapter.

If the capacity measurement tool 201 confirms that the discharge of the battery 126 is completed, it acquires the value of the discharge capacity from the EEPROM 126A through the BIOS 120A. Then, the tool 201 converts the discharge capacity into battery capacity and writes the value (full charge capacity at the time of correction) of the battery capacity, etc. to the EEPROM 126A through the BIOS 120A (block S21). The tool 201 displays the information of the computed battery capacity or the like on the screen of the LCD 17.

After that, if the system is powered off (block S22), the PSC 128 charges the battery 126 (block S23).

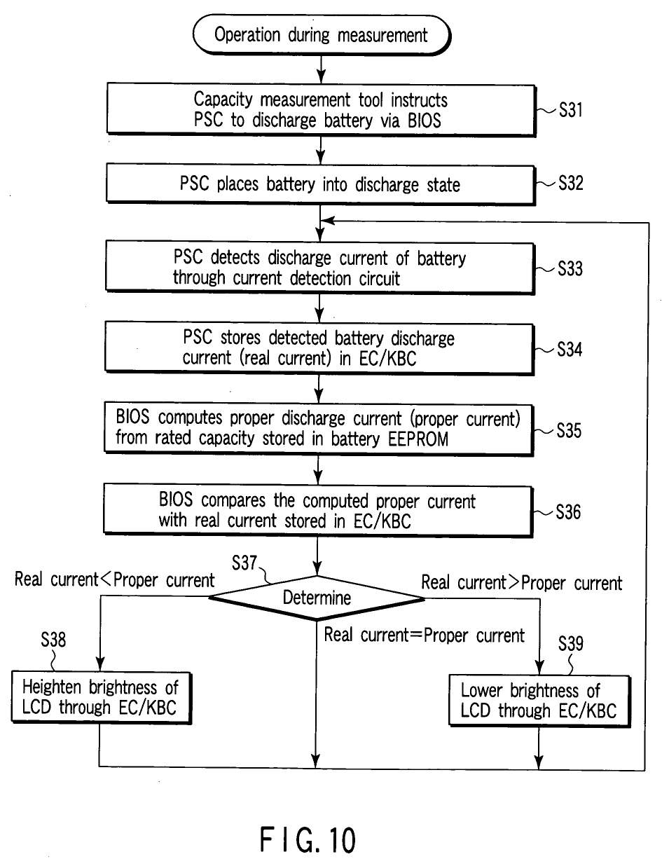

An operation for controlling the discharge current during the discharge will be described with reference to FIG. 10.

If the capacity measurement tool 201 instructs the PSC 128 to discharge the battery 126 via the BIOS 120A (block S31), the PSC 128 places the battery 126 into a discharge state (block S32).

The PCS 128 detects the discharge current of the battery 126 through the current detection circuit 129 (block S33) and stores the value of the detected discharge current (real current) in the EC/KBC 124 (block S34).

On the other hand, the BIOS 120A computes a value of the proper discharge current (proper current) from the rated capacity stored in advance in the EEPROM 126A (block S35), and compares the computed value with the real current stored in the EC/KBC 124 (block S36). The computation in block S35 has only to be performed once, and can be omitted next time.

The BIOS 120A determines a relationship in size between the value of the proper current and that of the real current (block S37). If the value of the real current is smaller than that of the proper current, the brightness of the LCD 17 is heightened through the EC/KBC 124. On the other hand, if the value of real current is larger than that of the proper current, the brightness of the LCD 17 is lowered through the EC/KBC 124. No operation is carried out when the value of the proper current and that of the real current coincide with each other.

The process after block S33 is repeated until the battery 126 is completely discharged.

According to the embodiment of the invention, even though discharge current varies with the operating condition and use environment of the information processing apparatus, the discharge capacity is measured while the discharge current is controlled to have a proper value. The battery capacity can thus be measured correctly and the exact diagnostic result can be obtained.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus comprising:
a battery;
a detection unit to detect a value of current discharged from the battery;
a device to be driven upon receipt of the current discharged from the battery;
a control unit to control the device to ensure that the value of current detected by the detection unit approaches a preset value; and
a computation unit to compute a capacity of the battery, based on the value of current detected by the detection unit, while the control unit controls the device.

2. The information processing apparatus according to claim 1, wherein:
the device includes a display unit; and
the control unit varies brightness of the display unit to control the device to ensure that the value of current detected by the detection unit approaches the preset value.

3. The information processing apparatus according to claim 1, wherein:
the device includes a display unit; and
the control unit powers on/off the display unit to control the device to ensure that the value of current detected by the detection unit approaches the preset value.

4. The information processing apparatus according to claim 1, wherein:
the device includes a processor; and
the control unit varies an operating frequency of the processor to control the device to ensure that the value of current detected by the detection unit approaches the preset value.

5. The information processing apparatus according to claim 1, further comprising a processing unit to disable a start of one of a suspend process and a hibernation process when an event to start the one of the suspend process and the hibernation process occurs while the computation unit is computing the capacity of the battery.

6. An information processing apparatus comprising:
a battery;
a detection unit to detect a value of current discharged from the battery;
a device to be driven upon receipt of the current discharged from the battery;
a control unit to compare the value of current detected by the detection unit with a preset value, and control the device to decrease power consumption of the device to ensure that the value of current becomes small if the value of current is larger than the preset value and control the device to increase the power consumption of the device to ensure that the value of current becomes large if the value of current is smaller than the preset value;
a measurement unit to measure a time period during which current is discharged from the battery; and
a processing unit to compute a capacity of the battery by a product of the value of current detected by the detection unit while the control unit controls the device and the time period measured by the measurement unit while the control unit controls the device.

7. A battery capacity measuring method applied to an information processing apparatus that drives a battery, the method comprising:
detecting a value of current discharged from the battery;
controlling a device to be driven upon receipt of the current discharged from the battery to ensure that the value of current approaches a preset value; and
computing a capacity of the battery, based on the value of current, while the device is being controlled.

8. The method according to claim 7, wherein the controlling includes varying brightness of a display unit included in the information processing apparatus to control the device to ensure that the value of current approaches the preset value.

9. The method according to claim 7, wherein the controlling includes powering on/off a display unit included in the information processing apparatus to control the device to ensure that the value of current approaches the preset value.

10. The method according to claim 7, wherein the controlling includes varying an operating frequency of a processor included in the information processing apparatus to control the device to ensure that the value of current approaches the preset-value.

11. The method according to claim 7, further comprising disabling a start of one of a suspend process and a hibernation process when an event to start the one of the suspend process and the hibernation process occurs while the capacity of the battery is being computed.
